(19) United States
(12) Patent Application Publication
(10) Pub. No.: US 2026/0357925 A1
(43) Pub. Date: Nov. 12, 2026

(54) COAXIAL GAS TUBE

(71) Applicant: Wain Research Operations LLC, Las Vegas, NV (US)

(72) Inventor: Joshua J. Parker, Rohnert Park, CA (US)

(21) Appl. No.: 19/716,042

(22) Filed: Jun. 22, 2026

Related U.S. Application Data
(63) Continuation-in-part of application No. PCT/US2024/061759, filed on Dec. 23, 2024.
(60) Provisional application No. 63/613,746, filed on Dec. 21, 2023.

(51) Int. Cl. F16L 9/18; F16L 55/07

(52) U.S. Cl. CPC F16L 9/18; F16L 55/07

(57) ABSTRACT

A tube assembly has an inlet end and an opposing outlet end. An outer tube has an inner surface, and an inner tube carried within the outer tube has an outer surface, the outer surface of the inner tube being spaced from the inner surface of the outer tube and forming a volume therebetween. A vane is located between the inner and outer tubes, with at least a portion of the vane being a longitudinal helix. The interior of the inner tube is a primary gas passage allowing gases to flow therethrough from the inlet end to the outlet end, and the volume is a secondary gas passage allowing gases to flow therethrough.

### CROSS-REFERENCE TO RELATED APPLICATIONS

This disclosure claims the benefit of the filing date of U.S. 63/613,746, filed on 21 Dec. 2023, and is a bypass continuation-in-part of PCT/US2024/061759, filed on 23 Dec. 2024, both titled COAXIAL GAS TUBE, the entire content of each being incorporated by reference.

### BACKGROUND

Gas tubes provide for the transport of gases from an inlet to an outlet and may be formed to have a selected size or shape for the application. A gas tube may be used in conjunction with another gas tube, such that each tube transport gases of different types. Alternatively, a single flow of gases may be split so that portions of the gases flow via separate tubes or paths within the tubes, and various means have been utilized for altering the velocity and pressure of the gases while flowing therethrough.

### BRIEF DESCRIPTION OF THE DRAWINGS

FIG. 1 is an oblique view of an embodiment of a coaxial gas tube according to this disclosure.

FIG. 2 is an oblique cross-section view of the tube of FIG. 1.

FIG. 3 is an enlarged cross-section side view of a portion of the tube of FIG. 1.

FIG. 4 is an oblique cross-section view of another embodiment of a coaxial gas tube according to this disclosure.

FIG. 5 is an enlarged oblique cross-section view of a portion of the tube of FIG. 4.

FIG. 6 is an oblique view of the tube of FIG. 4 with portions removed for viewing of internal structure.

FIG. 7 is an oblique cross-section view of another embodiment of a coaxial gas tube according to this disclosure.

FIG. 8 is an enlarged oblique cross-section view of a portion of the tube of FIG. 7.

FIG. 9 is an oblique view of the tube of FIG. 7 with portions removed for viewing of internal structure.

FIG. 10 is an oblique longitudinal cross-section view of another embodiment of a gas tube according to this disclosure.

FIG. 11 is an oblique lateral cross-section view of the gas tube of FIG. 10.

FIG. 12 is an oblique view of the gas tube of FIG. 10 with a portion removed.

FIG. 13 is an oblique longitudinal cross-section view of another embodiment of a gas tube according to this disclosure.

FIG. 14 is an oblique longitudinal cross-section view of the gas tube of FIG. 13.

FIG. 15 is an oblique lateral cross-section view of the gas tube of FIG. 13 with a portion removed.

### DETAILED DESCRIPTION

In the specification, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure divulges embodiments of a coaxial gas tube having a primary passage and a coaxial secondary passage comprising helical vanes.

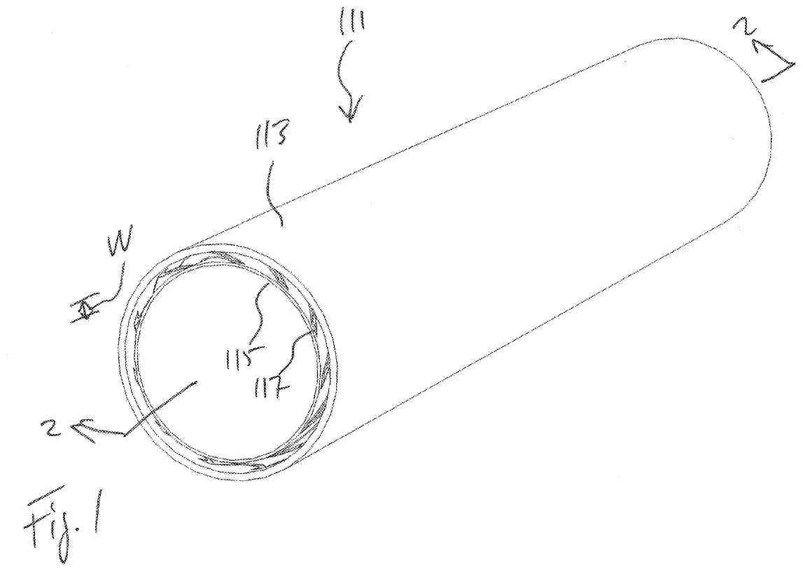

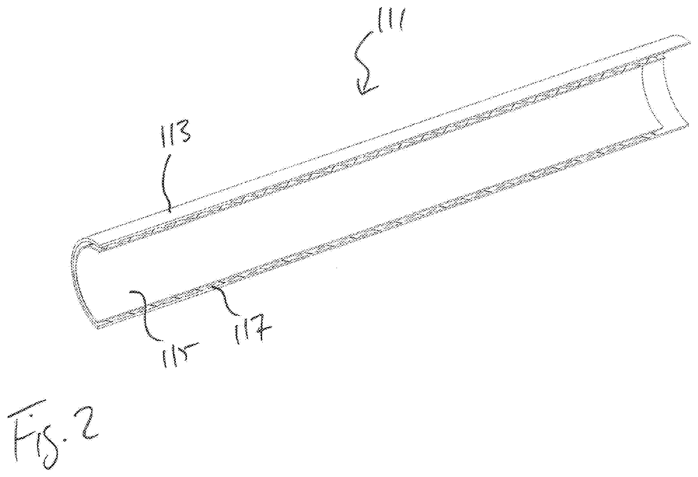

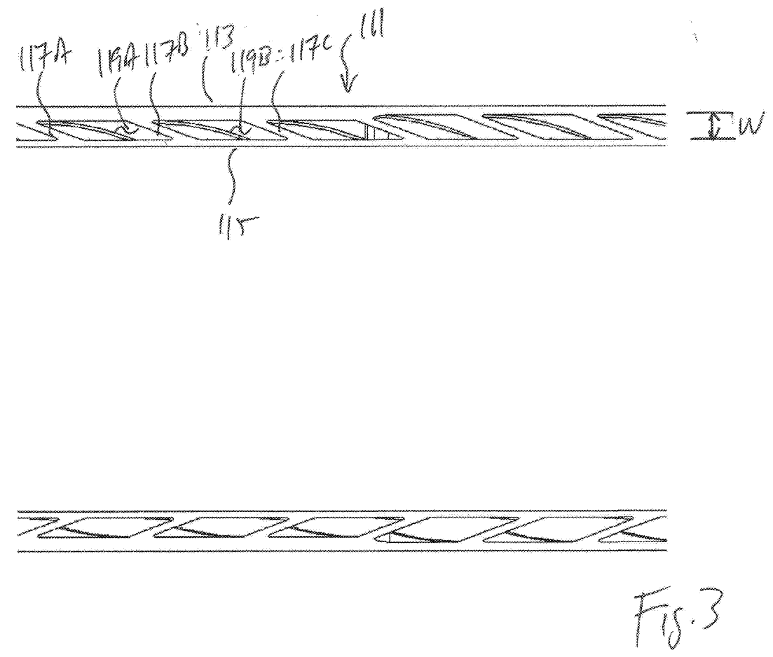

FIGS. 1 through 3 illustrate a coaxial gas tube 111 comprising an outer tube 113, an inner tube 115, and a plurality of helical vanes 117 located between tubes 113, 115. FIG. 1 is an end view of tube 111, FIG. 2 is a cross-section view taken along longitudinal plane 2-2 shown on FIG. 1, and FIG. 3 is an enlarged portion of the view of FIG. 2.

Inner tube 115 is coaxially carried within outer tube 113, so that a circumferential cylindrical space of width W is formed between tubes 113, 115. Inner tube 115 forms a primary passage for gases, and the space between tubes 113, 115 forms a secondary passage for gases. Subject to the requirements of a specific application, width W and the diameters of tubes 113, 115 may be of any selected size or ratio.

A plurality of vanes 117 are formed within the secondary passage, each vane being a longitudinal helix and having a radial height extending between the inner surface of outer tube 113 and the outer surface of inner tube 115. As visible in FIG. 3, individual vanes cooperate to form helical passages therebetween. For example, vane 117A and adjacent vane 117B cooperate to form helical passage 119A, and vane 117B and vane 117C cooperate to form adjacent helical passage 119B, each passage 119A, 119B curling around inner tube 115 and within outer tube 113.

Gas tube 111 may be used to change the pressure and/or velocity of gases traveling in either direction through the secondary passage. For example, a flow of gases directed to tube 111 may be divided, such that a portion of the gases travel through the primary passage within inner tube 115 and the remainder of the gases flow through the secondary passage between tube 113, 115. Vanes 117 force the gases in the secondary passage to travel a longer path than the gases in the primary passage, and this longer and helical path can reduce energy of the gases as they travel from the inlet to the secondary passage to the outlet of the secondary passage. The longer path of the secondary passage in a coaxial gas tube can also provide for the same effects of a tube having a longer length but with the packaging benefits of having a shorter tube.

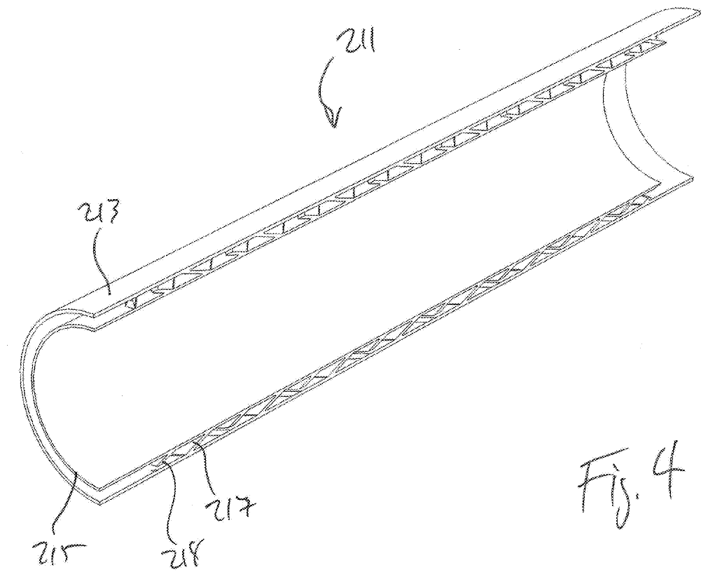

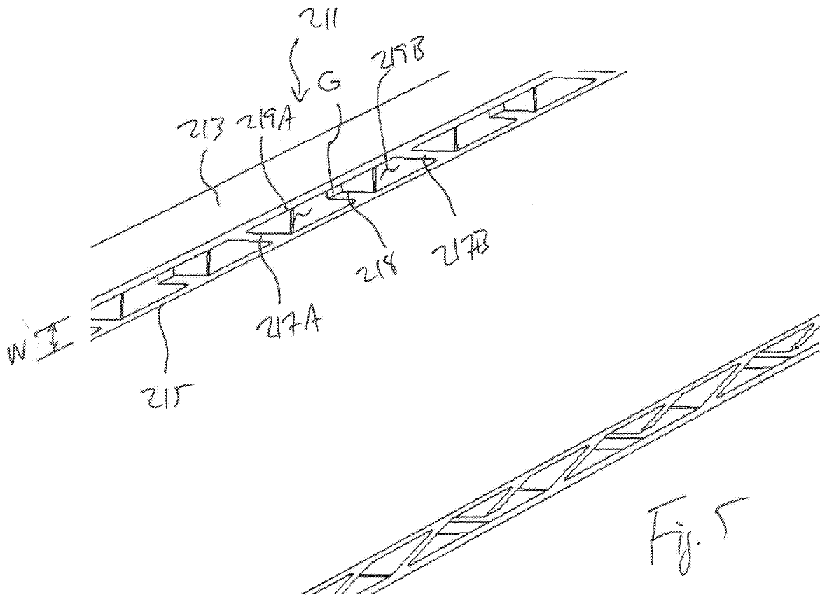

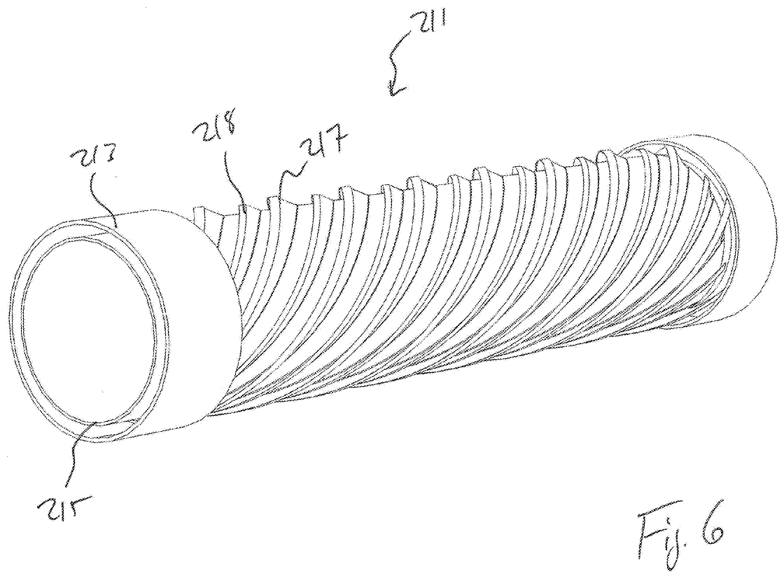

FIG. 4 through 6 illustrate a coaxial gas tube 211 comprising an outer tube 213, an inner tube 215, and a plurality of helical vanes 217, 218 located between tubes 213, 215. FIG. 4 is a cross-section view taken along a longitudinal plane interesting the central axis, FIG. 5 is an enlarged portion of the view of FIG. 4, and FIG. 6 is an oblique view with a portion of outer tube 213 removed for viewing vanes 217, 218.

Gas tube 211 is constructed similarly to gas tube 111, with inner tube 215 coaxially carried within outer tube 213 and a circumferential cylindrical space of width W formed between tubes 213, 215. Inner tube 215 forms a primary passage for gases, and the space between tubes 213, 215 forms a secondary passage for gases. Subject to the requirements of a specific application, width W and the diameters of tubes 213, 215 may be of any selected size or ratio.

A plurality of vanes 217, 218 are formed within the secondary passage, each vane being a longitudinal helix. Vanes 217 have a radial height extending between the inner surface of outer tube 213 and the outer surface of inner tube 215, whereas vanes 218 extend outward from inner tube 215 and terminate a selected distance from outer tube 213, thereby forming a gap G in vanes 218.

As visible in FIG. 5, individual vanes cooperate to form helical passages therebetween. For example, vane 217A and adjacent vane 218 cooperate to form helical passage 219A, and vane 218 and vane 217B cooperate to form adjacent helical passage 219B, each passage 219A, 219B curling around inner tube 215 and within outer tube 213. Unlike gas tube 111, as described above, gases flowing within helical passages 219A, 219B are able to flow between helical passages 219A, 219B through gap G.

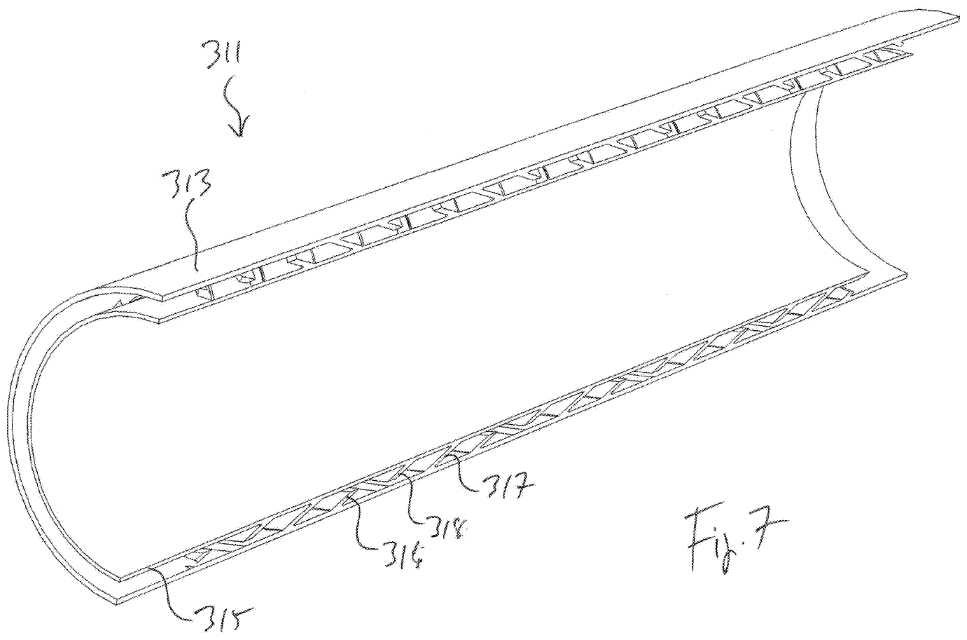

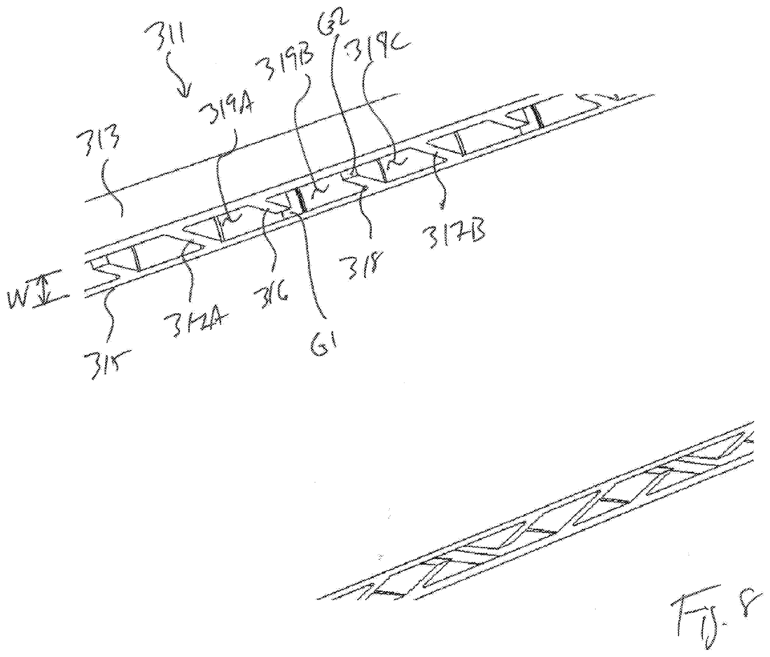

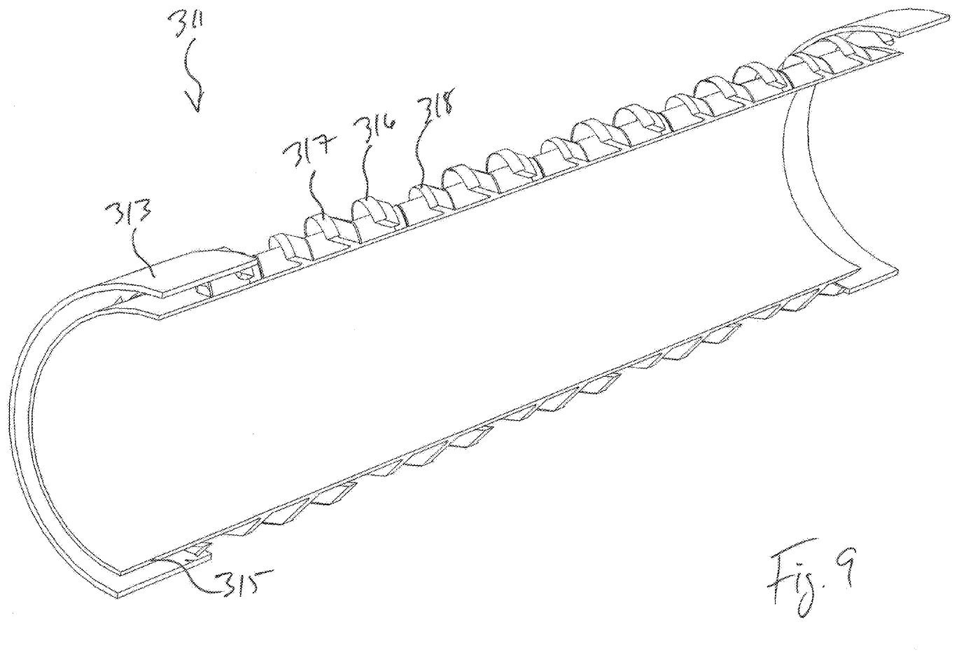

FIG. 7 through 9 illustrate a coaxial gas tube 311 comprising an outer tube 313, an inner tube 315, and a plurality of helical vanes 316, 317, 318 located between tubes 313, 315. FIG. 7 is a cross-section view taken along a longitudinal plane interesting the central axis, FIG. 8 is an enlarged portion of the view of FIG. 7, and FIG. 9 is an oblique view with a portion of outer tube 313 removed for viewing vanes 316, 317, 318.

Gas tube 311 is constructed similarly to gas tubes 111 and 211, with inner tube 315 coaxially carried within outer tube 313 and a circumferential cylindrical space of width W formed between tubes 313, 315. Inner tube 315 forms a primary passage for gases, and the space between tubes 313, 315 forms a secondary passage for gases. Subject to the requirements of a specific application, width W and the diameters of tubes 313, 315 may be of any selected size or ratio.

A plurality of vanes 316, 317, 318 are formed within the secondary passage, each vane being a longitudinal helix. Vanes 317 have a radial height extending between the inner surface of outer tube 313 and the outer surface of inner tube 315. Vanes 316 extend inward from outer tube 313 and terminate a selected distance from inner tube 315, thereby forming a gap G1 in vanes 316. Vanes 318 extend outward from inner tube 315 and terminate a selected distance from outer tube 313, thereby forming a gap G2 in vanes 318.

As visible in FIG. 8, individual vanes cooperate to form helical passages therebetween. For example, vane 317A and adjacent vane 316 cooperate to form helical passage 319A, vane 316 and vane 318 cooperate to form helical passage 319B, and vane 318 and vane 317B cooperate to form helical passage 319C, each passage 319A, 319B, 319C curling around inner tube 315 and within outer tube 313. Similar to gas tube 211, as described above, gases flowing within helical passages 319A, 319B, 319C are able to flow between passages 319A, 319B, 319C through gaps G1 and G2.

Several items should be noted for embodiments of a gas tube according to this disclosure. Though not shown, it should be understood that vanes may be interrupted by steps, breaks, vents, ports, etc., thereby communicating the helical passages. The helix of each vane will have a pitch that defines the length required for a complete revolution about the inner tube, and this may lead to vanes forming one full revolution, more than one revolution, or less than one revolution for a gas tube of a selected length. However, a vane having a helix of a selected pitch may be terminated at any length, with another cohelical vane beginning near the end of the adjacent vane and forming a gap between the ends. Alternatively, another vane having the same pitch may begin at an offset location, thereby forming a step between these vanes and allowing the flow of gases within the terminating helical passages to be divided into two or more subsequent helical passages. It should also be noted that vents or ports may be formed in the inner tube to allow gases to flow between the helical passages and the secondary passage. Also, vents may be formed in the outer tube to allow gases to pass out of the secondary passage. Helices of a gas tube may have varying pitch.

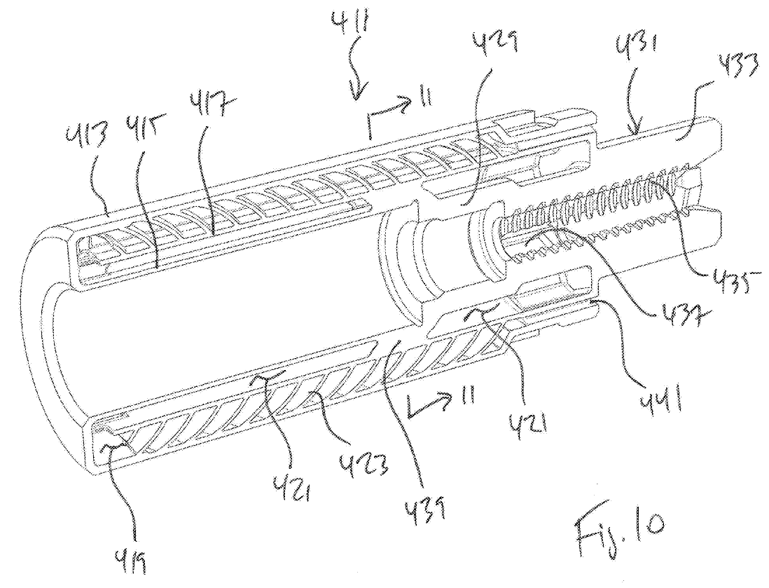

FIGS. 10 through 15 illustrate additional embodiments of coaxial gas tubes according to this disclosure.

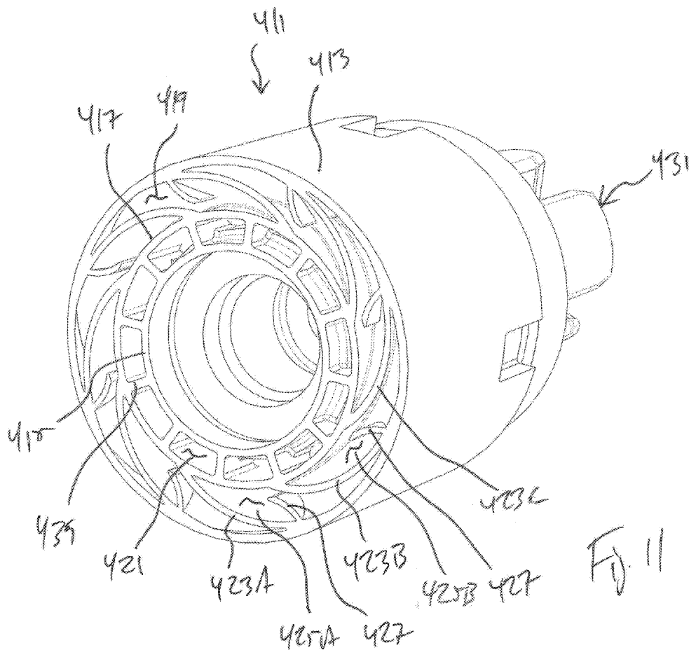

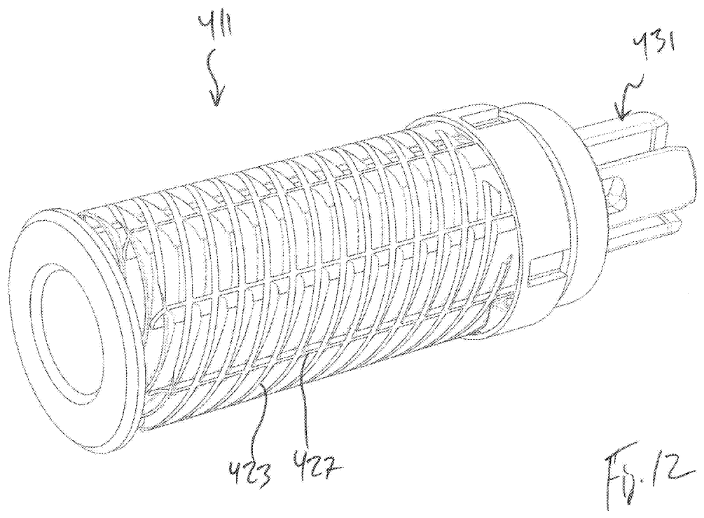

FIGS. 10 through 12 illustrate a coaxial gas tube 411 comprising an outer tube 413, an inner tube 415, and an intermediate tube 417. In the embodiment shown, gas tube 411 is configured as a flash hider for a firearm. FIG. 10 is a longitudinal cross-section view of gas tube 411, FIG. 11 is a lateral cross-section view taken along plane 11-11 shown on FIG. 10, and FIG. 12 is an oblique view showing gas tube 411 with outer tube 413 removed.

As shown, inner tube 415 and intermediate tube 417 are coaxially carried within outer tube 413, so that circumferential cylindrical outer chamber 419 is formed between tubes 413, 417 and inner chamber 421 is formed between tubes 415, 417. Tubes 413, 415, 417 are shown as coaxial, though the axes of tubes 415, 417 can be offset for causing varying cross-sectional areas within chambers 419, 421.

A plurality of vanes 423 are formed within outer chamber 419, each vane being a longitudinal helix and having a radial height extending between the inner surface of outer tube 413 and the outer surface of intermediate tube 417. As visible in FIG. 11, individual vanes cooperate to form helical passages 425 therebetween. For example, vane 423A and adjacent vane 423B cooperate to form helical passage 425A, and vane 423B and vane 423C cooperate to form adjacent helical passage 425B, each passage 425A, 425B curling around intermediate tube 417 and within outer tube 413.

Outer chamber 421 also comprises longitudinal flow disruptors 427 extending from a forward portion of chamber 421 to a rear portion of chamber 421 and intersecting helical vanes 423. Disruptors 427 have a radial height less than the distance between the inner surface of outer tube 413 and the outer surface of intermediate tube 417, thereby forming a gap between each disruptor 427 and tube 417 for allowing gases to continue flowing through passages 425. Disruptors 427 are shown as extending inward from outer tube 413, though disruptors 427 may alternatively extend outward from intermediate tube 417 or extend from each of tubes 413, 417, such as in an alternating configuration. As shown, each disruptor 427 is preferably curved about a longitudinal axis and curl toward the incoming flow of gases traveling through passages 425, though disruptors 427 may alternatively be planar and extend radially or be angled toward the incoming flow.

Gas tube 411 is configured for mounting to a muzzle of a firearm, which is received in mounting section 429. Gases flowing out of the muzzle enter a flash hider 431 that comprises prongs 433 extending forward, each prong 433 having a ribbed inner surface 435. A portion of the gases exits through flash hider 431, and another portion flows into an inlet port 437 located between each pair of adjacent prongs 433. Each inlet port 437 communicates with inner chamber 421, allowing for gases to flow from flash hider 431 into chamber 421 and travel rearward past separators 439. Gases then flow around the rear end of intermediate tube 417 and into outer chamber 419. The gases then flow forward through helical passages 425 and past disruptors 427 before exiting chamber 419 through ports 441.

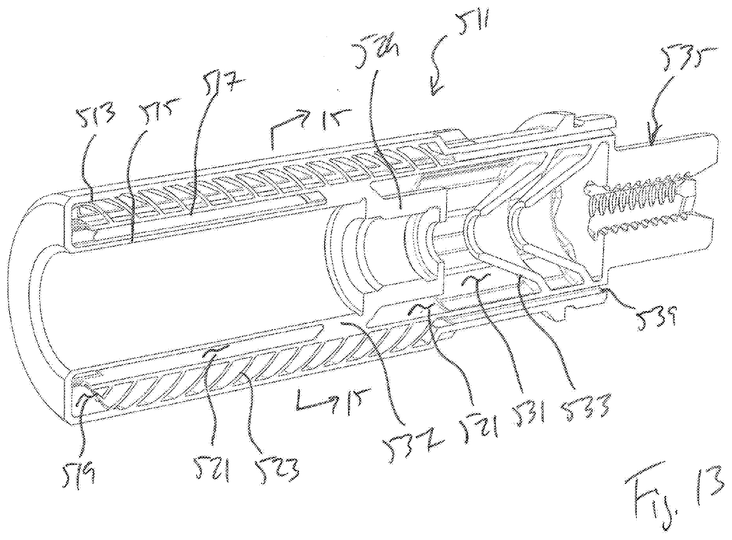

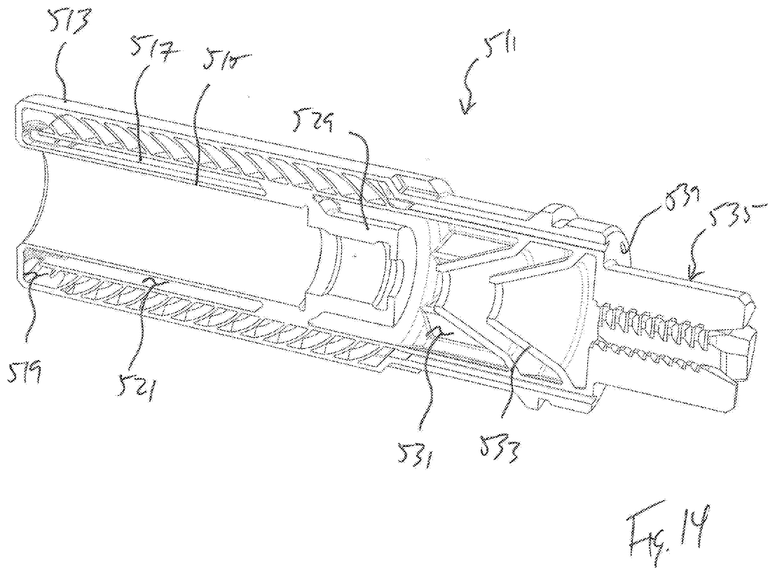

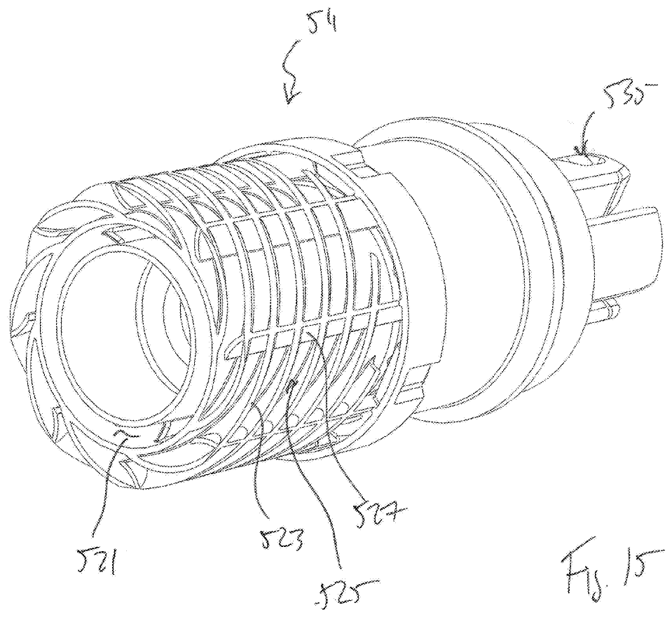

FIGS. 13 through 15 illustrate a coaxial gas tube 511 constructed similarly to tube 411 but configured a firearm suppressor. Tube 511 comprises an outer tube 413, an inner tube 415, and an intermediate tube 417. FIGS. 13 and 14 are longitudinal cross-section views of gas tube 511, and FIG. 15 is a lateral cross-section view taken along plane 15-15 shown on FIG. 13 and with outer tube 513 removed.

As with gas tube 411, inner tube 515 and intermediate tube 517 are carried within outer tube 513, so that circumferential outer chamber 519 is formed between tubes 513, 517 and inner chamber 521 is formed between tubes 515, 517. Tubes 513, 515, 517 are shown as coaxial, though the axes of tubes 515, 517 can be offset for causing varying cross-sectional areas within chambers 519, 521.

Each vane 523 within outer chamber 519 is a longitudinal helix and has a radial height extending between the inner surface of outer tube 513 and the outer surface of intermediate tube 517, thereby cooperating to form helical passages 525 therebetween. Outer chamber 521 also comprises longitudinal flow disruptors 527 extending from a forward portion of chamber 521 to a rear portion of chamber 521 and intersecting helical vanes 523. As described above for tube 411, disruptors 527 have a radial height less than the distance between the inner surface of outer tube 513 and the outer surface of intermediate tube 517, thereby forming a gap between each disruptor 527 and tube 517, and various alternative configurations of disruptors 527 are described above.

Gas tube 511 is configured for mounting to a muzzle of a firearm, which is received in mounting section 529. Gases flowing out of the muzzle enter a core chamber 531 comprising baffles 533, a portion of the gases flowing out of a flash hider 535, another portion of the gases flowing out of core chamber 531 into inner chamber 521. Gases in inner chamber 521 flow rearward past separators 537, around the rear end of intermediate tube 517, and into outer chamber 519. The gases in outer chamber 519 then flow forward through helical passages 525 and past disruptors 527 before exiting chamber 519 through ports 539.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A tube assembly having an inlet end and an opposing outlet end, the assembly comprising:
an outer tube having an inner surface;
an inner tube carried within the outer tube and having an outer surface, the outer surface of the inner tube being spaced from the inner surface of the outer tube and forming a volume therebetween;
a vane located between the inner and outer tubes, at least a portion of the vane being a longitudinal helix;
wherein the interior of the inner tube is a primary gas passage allowing gases to flow therethrough from the inlet end to the outlet end, and the volume is a secondary gas passage allowing gases to flow therethrough.

2. The assembly of claim 1, wherein the vane extends between the outer surface and the inner surface.

3. The assembly of claim 1, wherein the vane extends outward from the outer surface, the outer radial end of the vane being spaced from the inner surface.

4. The assembly of claim 1, wherein the vane extends inward from the inner surface, the inner radial end of the vane being spaced from the outer surface.

5. The assembly of claim 1, wherein the secondary passage is adapted for gases to flow in either direction therethrough.

6. The assembly of claim 1, wherein a first portion of gases entering the inlet end flow through the secondary passage, and a second portion of gases entering the inlet end flow through the primary passage.

7. The assembly of claim 1, wherein the vane comprises multiple longitudinal segments.

8. The assembly of claim 1, wherein the vane comprises multiple longitudinal segments, the segments being cohelical.

9. The assembly of claim 1, wherein the vane comprises multiple longitudinal segments, the segments being offset from each other.

10. The assembly of claim 1, further comprising:
a port formed in the inner tube for allowing gases to flow between the primary and secondary passages.

11. The assembly of claim 1, further comprising:
a vent formed in the outer tube to allow gases to pass out of the secondary passage.

12. The assembly of claim 1, wherein the helix of the vane has a varying pitch.

13. The assembly of claim 1, wherein the volume of the secondary passage varies based on longitudinal position.

14. The assembly of claim 1, wherein the volume of the secondary passage varies based on angular position about a central axis of the assembly.
